(19) United States
(12) Patent Application Publication
(10) Pub. No.: US 2020/0247380 A1
(43) Pub. Date: Aug. 6, 2020

(54) Method for Operating a Braking Mechanism, Control Device for a Braking Mechanism of Said Type, Braking Mechanism, and Vehicle Comprising a Braking Mechanism of Said Type

(71) Applicant: Robert Bosch GmbH, Stuttgart (DE)

(72) Inventors: Frank Baehrle-Miller, Schoenaich (DE); Andreas Englert, Untergruppenbach (DE); Tobias Putzer, Bad Friedrichshall (DE)

(21) Appl. No.: 15/774,502

(22) PCT Filed: Nov. 7, 2016
(86) PCT No.: PCT/EP2016/076838

§ 371 Date: May 8, 2018

(30) Foreign Application Priority Data
Dec. 9, 2015 (DE) 10 2015 224 720.1

(51) Int. Cl. B60T 13/74; F16D 55/226

(52) U.S. Cl. CPC B60T 13/741; B60T 13/746; F16D 2121/04; B60T 2270/413; F16D 55/226

(57) ABSTRACT

A method for operating a braking mechanism includes controlling an actuator comprising an electric motor in such a way as to move an actuator element into a predefined position. Upon completion of the controlling action on the actuator, at least one motor coasting variable is measured. On the basis of the measured motor coasting variable, it is verified whether the actuator element has moved into the predefined position.

The invention relates to a method for operating a braking mechanism, a control device for a braking mechanism of this type, a braking mechanism for a vehicle and a vehicle having a braking mechanism of this type.

### PRIOR ART

By way of example, DE 10 2012 205 576 A1 discloses a braking mechanism having an electromotive actuator that may selectively displace an actuator element into a brake application position or into a brake release position. The term “a brake application position” is understood as a position in which a clamping force that is also referred to as a brake application force is supplied between brake linings, which are influenced with a force by means of the actuator element, and a brake disc. For this purpose, typically a rotational movement of the electric motor is converted via a gear spindle unit into a translational movement of the actuator element. Each time the electric motor is actuated for a brake application procedure, it is initially necessary to move through two idle travel distances, namely the play that is also referred to as clearance that is always present at the beginning between the actuator element and where applicable a brake piston that is to be displaced and pressed by means of the actuator element against the brake disc, and the play between the brake linings and the brake disc. Only after moving through said two idle travel distances is a normal force, the so-called brake application force, built up on the brake disc.

New demands will be placed on braking mechanisms that are in particular configured as parking brake devices, in particular as a result of functions that are provided in the future such as a highly automated parking procedure, wherein the driver is not sitting in the vehicle. In the event of a failure of a hydraulic braking apparatus of the vehicle, the parking brake device is used for safety reasons as a necessary fallback level. Studies have discovered that in order to fulfill the safety-related requirements, an actuating time of less than 200 ms is necessary. In order to render such short actuating times possible, it is necessary to keep the clearance as small as possible and therefore to keep an idle travel distance of the actuator element until the development of force as short as possible. However, it is simultaneously necessary to ensure that a—if where applicable also small—development of force does not already occur accidentally, which would lead to the buildup of an undesired braking force and where applicable would lead to the brakes squeaking when parking the vehicle.

It is preferably possible to estimate or to calculate a travel distance that is covered by the actuator element in particular with reference to operating variables of the electric motor. However, malfunctions may occur that result in a deviation of the actually achieved actuator element position with respect to the expected position of the actuator element. If the actuator element is therefore to travel to a predetermined position, it is in fact possible to estimate or to calculate whether the actuator element has achieved the predetermined position, however, it is not possible to perform a check for this.

### DISCLOSURE OF THE INVENTION

The object of the invention is to provide a method for operating a braking mechanism, a control device for a braking mechanism of this type, a braking mechanism of this type and a vehicle having a braking mechanism of this type, wherein the mentioned disadvantages do not occur.

The object is achieved in that the subject matters of the independent claims are provided. Advantageous embodiments are provided in the dependent claims.

The object is achieved in particular in that a method for operating a braking mechanism is provided, wherein an actuator that comprises an electric motor is actuated in order to displace an actuator element into a predetermined position, wherein after the procedure of actuating the actuator is terminated at least one motor coasting variable is ascertained and wherein with reference to the ascertained motor coasting variable, a check is performed as to whether the actuator element has been displaced into the predetermined position. The method comprises advantages in comparison with the prior art. In particular, it is possible within the scope of the method to check whether the actuator element has actually been displaced into the predetermined position or has arrived in an incorrect position that deviates from the predetermined position. This check may be performed in a simple and economical manner by means of ascertaining and evaluating the motor coasting variable, wherein this may preferably be a variable that is already ascertained in the case of operating the braking mechanism—by way of example so as to estimate or calculate a brake application force—with the result that an additional sensor system is not required in order to implement the method. It is only necessary to implement the method in a controller of the braking mechanism. Within the scope of the method, it is in particular possible to expediently reduce the clearance of the actuator element in a desired manner and therefore to ensure in particular a rapid actuating time for the braking mechanism. It is preferred that within the scope of the method, a parking brake device is operated, in particular a so-called automatic parking brake system (APB). This preferably requires electromotive actuators on rear wheel brakes of a vehicle. The actuator element is preferably integrated into a piston of an operating brake. The clamping force of a rear axle is mainly applied via a threaded spindle that is driven via a direct current motor transmission unit and acts upon a base of the brake piston. A high clamping force may be built up in a short period of time and may be maintained.

The term a “predetermined position” is understood to mean in particular a position of the actuator element in relation to a braking element, in particular a brake piston, which may be displaced by means of the actuator element. This is preferably not an absolute position but rather a position that is described by virtue of the fact that either—in a first case—a—preferably reduced—clearance therefore exists as a gap between the actuator element and the braking element or in that already a—if also preferably still small—brake application force or clamping force is built up, wherein a clearance no longer exists. In accordance with one embodiment of the method, the predetermined position is therefore characterized by virtue of the fact that the clearance in comparison to a starting position from which the actuator element is displaced is reduced but is greater than zero, wherein the predetermined position in the case of another embodiment of the method is characterized by virtue of the fact that the clearance is zero and already an initial brake application force, preferably less than 2 kN, is built up.

The term a “motor coasting variable” is in particular understood to mean a variable that characterizes the manner in which the electric motor is running after an actuating procedure is terminated. It is preferred that the “motor coasting variable” is ascertained in dependence upon time, wherein in particular a time-dependent curve of the motor coasting variable is ascertained and with reference to said curve a check is performed as to whether the actuator element has been displaced into the predetermined position. Since the motor coasting variable characterizes the motor run of the electric motor after an actuating procedure is terminated, it is possible with reference to the motor coasting variable and in particular with reference to its curve to establish whether the electric motor—in the case of a remaining clearance—may run freely or whether said electric motor—in the case of a reduction of the clearance to zero and in particular in the case of building up a brake application force—the electric motor is abruptly braked.

In accordance with a further development of the invention, it is provided that the procedure of actuating the actuator is terminated in dependence upon parameters. This has the advantage that at least one criterion for terminating the actuating procedure may be used with the result that the predetermined position is already achieved in a particularly safe manner. Remaining uncertainties with regards to achieving the predetermined position may be eliminated within the scope of the method by means of the test that is proposed. By way of example, a time that has elapsed since the start of the actuating procedure, a number of rotations of the electric motor since the start of the actuating procedure, a motor angular velocity that is achieved, an electrical variable of the electric motor, by way of example a motor current, an estimated displacement travel distance and/or a calculated displacement travel distance of the actuator element may be used as parameters for terminating the procedure of actuating the actuator. It is preferably provided that the procedure of actuating the actuator, therefore the procedure of actuating the electric motor, is terminated prior to the predetermined position being achieved with the result that the electric motor may coast into the predetermined position. This increases the safety when achieving the predetermined position in particular if the coasting behavior of the electric motor is known.

In accordance with a further development of the invention, it is provided that a motor angular velocity of the electric motor is ascertained as a motor coasting variable. In this case, the motor angular velocity is therefore ascertained in particular after the procedure of actuating the actuator is terminated, in particular in dependence upon time. In particular, it may then be concluded from the temporal curve of the motor angular velocity whether a further final clearance is present in the end position that is achieved by the actuator element or whether said actuator element has already built up a brake application force. In particular, in the first mentioned case the motor angular velocity is continuously dropping and is preferably differentiable, wherein in the second case, at least one non-differentiable position occurs in the curve of the motor angular velocity or even a discontinuity occurs.

Alternatively or in addition thereto, it is preferably provided that a motor current through the electric motor is ascertained as a motor coasting variable. Since at the point in time of ascertaining the at least one motor coasting variable the actuating procedure has already been terminated, said motor coasting variable is not an actuation current that is provided to the electric motor from the outside but is rather conversely a braking current that is generated by the electric motor itself. The motor current also indicates in particular a characteristic, time-dependent curve depending upon whether a final clearance is present in the final end position that is achieved by the actuator element or whether said actuator element is already building up a clamping force.

Alternatively or in addition thereto, an in particular induced motor voltage may also be ascertained as a motor coasting variable.

In accordance with a further development of the invention, it is provided that a temporal development of a gradient of the motor coasting variable is evaluated. The term “a gradient of the motor coasting variable” is in particular to be understood as a temporal gradient, in particular a derivation of the motor coasting variable according to the time. The term “a temporal development of the gradient” is understood to mean a change of a value of the gradient over time. It is particularly preferred that a temporal development of an amount of the gradient is evaluated. It is possible in a simple and safe manner to derive information regarding the position that is achieved by the actuator element from the temporal development of a gradient of the motor coasting variable after the procedure of actuating the actuator is terminated and it is possible in particular to determine whether the actuator element has been displaced into the predetermined position.

In accordance with a further development of the invention, it is provided that a clearance of the actuator element is identified if a continuous development of the gradient is observed. In particular, it is identified that the actuator element comprises a further clearance, in particular a final clearance, after the actuating procedure is terminated and the electric motor is coasting. Since in this case the actuator element is not stopped on a further element, a discontinuity does not occur in the development of the gradient.

The term “a continuous development of the gradient” is in particular to be understood as a continuous reduction in particular of an amount of the gradient. Both the motor angular velocity as well as the motor current as motor coasting variables go to zero, namely at the end of the displacement of the actuator element with the result that the amount of the gradient falls over time.

In addition or alternatively, a load change of the actuator is preferably identified if a discontinuity in the development of the gradient is observed. A discontinuity in the development of the gradient may indicate a changed load—in particular by means of the actuator element being stopped on a further element—in particular a load step.

Depending upon which predetermined position the actuator element is to be displaced into, it is possible that a continuous development of the gradient is expected or that a discontinuity is expected in the development of the gradient. If a final clearance is to be present in the predetermined position, a continuous development of the gradient is expected. Conversely, if the actuator element is to be stopped on a further element, in particular whilst building up a specific initial brake application force, a load change and therefore a discontinuity is expected in the development of the gradient.

In addition or alternatively, it is therefore provided that in the case of an expected continuous development and an observed discontinuity in the development of the gradient an additional procedure of actuating the actuator is performed. Alternatively or in addition, in the case of an expected discontinuity in the development and an observed continuous development of the gradient an additional procedure of actuating the actuator is performed. In the two cases, it is namely established that the actuator element has not been displaced into the predetermined position. In the first case, a final clearance is expected in the predetermined position, wherein a stop of the actuator element is observed; in the second case a stop and where applicable the development of a specific brake application force is expected, wherein a final clearance clearly remains. In the two cases, an additional procedure of actuating the actuator is preferably performed in order to achieve the predetermined position using the additional actuating procedure.

The method may be performed recursively, wherein after terminating the additional procedure of actuating the actuator in turn a motor coasting variable is ascertained and with reference to the ascertained motor coasting variable a check is performed as to whether the actuator element has been displaced into the predetermined position. If this is in turn not the case, an additional procedure of actuating the actuator can be performed again. However, it is also possible that the additional actuating procedure is only performed once, wherein it is assumed that the predetermined position has been achieved owing to the additional actuating procedure.

In accordance with a further development of the invention, it is provided that in the case of an expected continuous development and an observed discontinuity in the development of the gradient, a reversing procedure of actuating the actuator is performed. The term “a reversing actuating procedure” is understood to mean an actuating procedure that is the opposite of the actuating procedure that is previously performed in order to displace the actuator element into the predetermined position, wherein the reversing actuating procedure is performed in particular in the release direction of the actuator element, therefore away from the brake application position. Therefore, if a clearance is expected but it is established that the actuator element is stopped, said actuator element is preferably displaced backwards by means of a reversing procedure of actuating the actuator in order to produce the clearance.

Alternatively or in addition, in the case of an expected discontinuity in the development and an observed continuous development of the gradient, the actuator is actuated back into the original actuating procedure. In this case, it is expected that the actuator element provides a stop and a specific brake application force develops by means of the actuator element, wherein a remaining final clearance is observed. The actuator is therefore again actuated back into the original actuating procedure with the result that the actuator element is further displaced into the same direction in order to cause a stop and/or to cause the buildup of a brake application force using the additional actuating step.

In accordance with a further development of the invention, it is provided that the electric motor is operated in a braking operation after the actuating procedure is terminated. This is advantageous because the electric motor may thus be braked in a defined manner and preferably in a manner that may be estimated or calculated with the result that the further displacement of the actuator element may be essentially predicted after the actuating procedure has been terminated. The electric motor is preferably actively braked in the braking operation.

In accordance with a further development of the invention, it is provided that in the braking operation two switching elements of a same side of two sides of a four-quadrant chopper are closed and two switching elements of the other side of the two sides of the four-quadrant chopper are open. A four-quadrant chopper represents a conventional actuating device for an electric motor and said four-quadrant chopper is also referred to as an H-bridge. A four-quadrant chopper of this type comprises a first side that is high in relation to the electric potential and a second side that is low in relation to the electric potential, in particular connected to ground, wherein the electric motor comprises two motor connectors, wherein each motor connector may be electrically connected via two switching elements that may be actuated separately either to the high first side or to the low second side of the four-quadrant chopper. If the two switching elements of a same side, by way of example of the first side or of the second side, of the four-quadrant chopper are closed and simultaneously the two switching elements of the other side are open, a short circuit for the electric motor occurs via the one side having the closed switching elements, wherein said electric motor produces with the rest of its rotational energy an electrical short circuit current by means of which—or by means of the resulting induced voltage—said electric motor is actively braked. This type of braking operation consequently represents a particularly efficient possibility for actively braking the electric motor by means of accordingly actuating the switching elements of the four-quadrant chopper.

The switching elements of the four-quadrant chopper are preferably provided as transistors, in particular as field effect transistors, particularly preferably as MOSFETs.

The object is also achieved in that a control device for a braking mechanism, in particular for a parking brake device, is provided and said control device is configured so as to implement a method according to any one of the above-described embodiments. In particular, the advantages that have already been explained in relation to the method are realized in relation to the control device.

The control device is in particular configured in order to actuate an actuator of the braking mechanism and to ascertain a motor coasting variable after the procedure of actuating the actuator is terminated and also to check with reference to the ascertained motor coasting variable whether the actuator element of the braking mechanism is displaced into a predetermined position. In particular, the control device is preferably configured in order to terminate the procedure of actuating the actuator in dependence upon parameters, in particular in dependence upon a travel distance estimation and/or a travel distance calculation for the displacement travel distance of an actuator element.

It is possible that the control device comprises precisely one control unit. However, it is also possible that the functionality of the control device is distributed amongst a plurality of control units that are operatively connected to one another.

The object is also achieved in that a braking mechanism, in particular a parking brake device, is provided for a vehicle, wherein the braking mechanism comprises an actuator that comprises for its part an electric motor, wherein a control device is provided that is configured so as to implement a method according to one of the above-described embodiments. It is preferred that the control device is provided according to any one of the above-described exemplary embodiments. In particular, the advantages that have already been explained in relation to the control device and the method are realized in relation to the braking mechanism.

The braking mechanism is preferably configured as an automatic parking brake system (APB).

In accordance with a further development of the invention, it is provided that a current measuring device is allocated to the electric motor and said current measuring device is arranged electrically between a switching element of a four-quadrant chopper and a motor connector of the electric motor for the four-quadrant chopper. The motor current may be ascertained in a simple manner as a motor coasting variable with the aid of the current measuring device. The fact that the current measuring device is arranged electrically between a switching element of the four-quadrant chopper and a motor connector for the electric motor means that it is not mandatory for the current measuring device to be arranged in a spatially geometric manner between these elements, which however may be the case but rather that said current measuring device is electrically connected to the switching element and the motor connector in series with the result that a current flows through the switching element to the motor connector via the current measuring device.

The braking mechanism preferably comprises two current measuring devices. In this case, a redundancy is provided in relation to ascertaining the motor current as a motor coasting variable.

It is possible that the current measuring devices are arranged symmetrically on the electric motor, wherein in particular each of two motor connectors is allocated a current measuring device. However, it is also possible that one of the two motor connectors of the electric motor are allocated the two current measuring devices with the result that said current measuring devices are arranged in series with one another between one and the same switching element and one and the same motor connector.

The object is finally also achieved in that a vehicle, in particular a motor vehicle, is provided with a braking mechanism according to any one of the above-described exemplary embodiments. In particular, the advantages that have already been explained in relation to the method, the control device and the braking mechanism are realized in relation to the vehicle.

In accordance with a preferred embodiment, the vehicle is configured as a motor vehicle in particular as a passenger car. However, it is also possible that the vehicle is configured as a truck or commercial vehicle.

In accordance with a preferred embodiment, the vehicle is configured so as to perform a highly-automated parking procedure, wherein it is provided that the driver it not present in the vehicle during the parking procedure, wherein conversely the vehicle itself performs the parking procedure autonomously and independently of the driver.

The control device comprises preferably—in particular exclusively—sampled signals of a supply voltage uₛ(t) as well as the motor current i_{A}(t). By means of the following equation:

$$ω ( t ) = \frac{1}{{K}_{m}} \cdot [ {u}_{s} ( t ) - {R}_{g e s} \cdot {i}_{A} ( t ) ] \qquad ( 1 )$$

that may be derived from the electrical as well as the mechanical differential equation for the system of the braking mechanism, the angular velocity ω(t) of the electric motor, which is configured in particular as a direct current motor, may be determined by means of the sampled signals of the motor current i_{A}(t), as well as the supply voltage uₛ(t). The equation (1) likewise includes the strength of the temperature, aging as well as parameters of the motor constant K_{M} that are dependent upon production tolerances, as well as the system resistance of the braking mechanism R_{ges}. The motor constant K_{M} and the system resistance R_{ges} may be determined by way of example by means of a method as is disclosed in the German laid-open specification DE 10 2006 052 810 A1, or the German laid-open specification DE 10 2012 205 576 A1, wherein in this respect reference is made to these documents.

If the electric motor is operated in the braking operation in that two switching elements of a same side of a four-quadrant chopper are closed and two switching elements of the other side of the four-quadrant chopper are open, the curve of the induced current in the short circuit of the four-quadrant chopper in dependence upon the provided circumstances, in particular a load torque that is present or missing, takes on characteristic features that may be detected by means of a sampling procedure and a procedure of identifying the gradient of the current curve. In addition or alternatively, it is also possible in lieu of the motor current to ascertain the induced motor voltage as a motor coasting variable. In the braking operation the electric motor acts as a current source. The following relationship applies:

$${u}_{M} ( t ) = {R}_{M} \cdot {i}_{A} ( t ) + L \cdot \frac{d {i}_{A} ( t )}{dt} + {K}_{M} \cdot ω ( t ) \qquad ( 2 )$$

wherein u_{M}(t) is the motor voltage at the motor connectors of the electric motor, wherein R_{M} is the electrical resistance of the electric motor, and wherein L is the inductivity of the electric motor. By means of reliably adopting an insignificantly low inductivity

$$L \cdot \frac{d {i}_{A} ( t )}{dt} = 0 \qquad ( 3 )$$

and taking into account that the motor voltage u_{M}(t) at the motor connectors goes to 0 in the braking operation, the differential equation (2) in the braking operation after converting according to the motor current i_{A}(t) is represented as follows:

$${i}_{A} ( t ) = - \frac{{K}_{M}}{{R}_{M}} \cdot ω ( t ) \qquad ( 4 )$$

The current that is flowing is only still dependent upon the motor parameters K_{M} and R_{M} that do not change at this moment, as well as upon the angular velocity ω(t).

The mechanical behavior of the electric motor may be described by means of the following mechanical differential equation of direct current machines:

$$J \cdot \frac{dω ( t )}{dt} = {K}_{M} \cdot {i}_{A} ( t ) - {M}_{R} ( t ) - {M}_{L} ( t ) \qquad ( 5 )$$

J is the inertial torque of the electric motor, M_{R}(t) is the frictional torque that occurs owing to the rotation of the actuator, and M_{L}(t) is the load torque that counteracts the rotation of the electric motor. If the electric motor is coasting without a load torque that counteracts said electric motor and that corresponds to an active braking procedure so as to position the actuator element using the remaining residual clearance it is thus evident from the mechanical differential equation (5) that the frictional torque M_{R}(t) that occurs by means of the rotation of the electric motor counteracts said electric motor. The load torque M_{L}(t) is precisely 0.

However, if the actuator element makes contact with a further element as a result of a desired or undesired actuating procedure, wherein in particular a final clamping force is built up, the load torque M_{L}(t) that is different from 0 is thus added to the frictional torque M_{R}(t). This additional load torque may be detected by means of the sampling procedure in the braking operation in accordance with equation (4).

The invention is further explained with reference to the drawing. In the drawing:

FIG. 1 illustrates schematically an exemplary embodiment of a braking mechanism of a vehicle having an integrated parking brake function in a simplified sectional view;

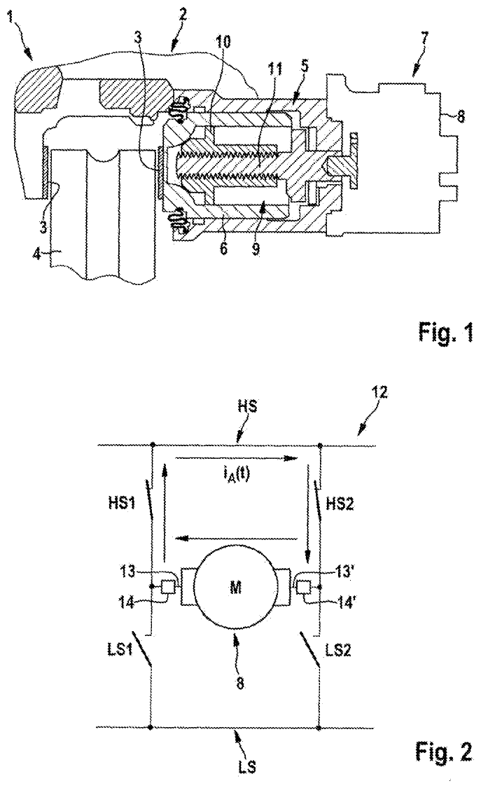

FIG. 2 illustrates schematically an interconnection of an electric motor with a four-quadrant chopper in the braking operation;

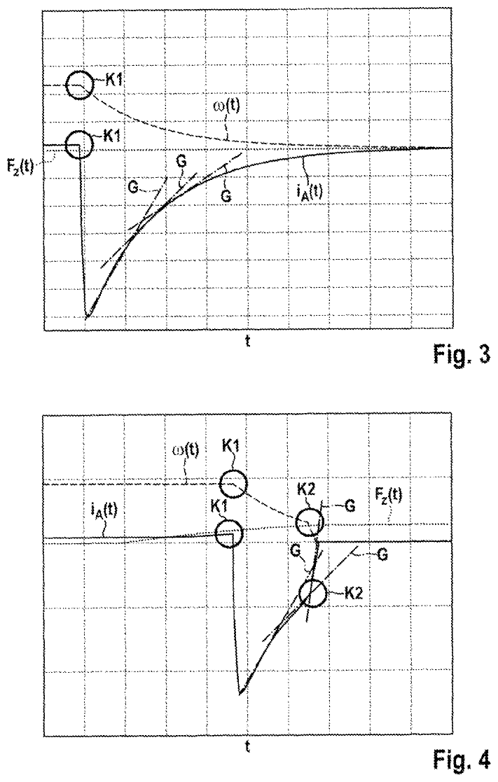

FIG. 3 illustrates a diagram of a braking procedure of the braking mechanism without a load torque occurring;

FIG. 4 illustrates a braking procedure of the braking mechanism with a load torque occurring, and

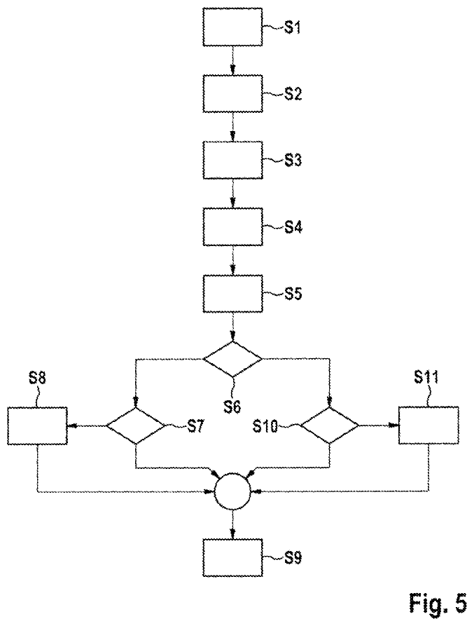

FIG. 5 illustrates schematically an embodiment of a method for operating a braking mechanism in the manner of a flow diagram.

FIG. 1 illustrates in a simplified sectional view a braking mechanism 1 of a motor vehicle that is not further illustrated in the figure. The braking mechanism 1 is provided as a disk brake and comprises for this purpose a brake caliper 2 that supports brake linings 3 and a brake disk 4 that is connected to a wheel of the motor vehicle in a rotationally secure manner may be jammed or clamped between said brake linings. For this purpose, a hydraulic actuator 5 is allocated to the brake caliper 2 and said hydraulic actuator comprises a brake piston 6 that may be hydraulically actuated in order to clamp the brake disk 4 on demand between the brake linings 3. As a consequence, in the driving operation, a braking torque is applied to the brake disk 4 and therefore to the wheels and said braking torque is used for the purpose of decelerating the vehicle.

The braking mechanism 1 is furthermore configured as a parking brake device or comprises by way of example a parking brake function and for this purpose comprises an electromotive actuator 7 that is formed from an electric motor 8, an actuator gear 9 that is configured as a spindle gear, and an actuator element 10. An output shaft of the electric motor 8 is connected in a rotationally secure manner to a drive spindle 11 of the actuator gear 9.

The drive spindle 11 comprises an outer thread that cooperates with an inner thread of the actuator element 10 that may be moved along the drive spindle 11. The drive spindle 11 is set into a rotational movement by means of actuating the electric motor 8 in order to displace the actuator element 10. The actuator element 10 may be displaced from a release position into a brake application position in which said actuator element pushes the brake piston 6 against the brake disk 4 and as a consequence clamps the brake caliper 2. The actuator element 10 is arranged for this purpose coaxially with respect to the brake piston 6 and within the brake piston 6. The rotational movement of the drive spindle 11 is converted into a translational movement of the actuator element 10 by means of the actuator gear 9. In this respect, the wheel braking mechanism corresponds to known wheel braking mechanisms.

In particular in the case of using the braking mechanism as an automatic parking brake system (APB) and especially during the highly-automated parking procedure of the motor vehicle, it is necessary to ensure as short as possible an actuating time, in particular shorter than 200 ms, for the braking mechanism 1. This may in particular be achieved in that the actuator element 10 is arranged in a predetermined position by means of the electromotive actuator 7 prior to an actual braking procedure, in particular said position having a reduced clearance or having already built up an initial clamping force stage, by way of example having a clamping force of less than 2 kN. It is possible to actuate the actuator 7 and in particular the electric motor 8 to displace the actuator element 10, and it is possible to terminate the actuating procedure in dependence upon parameters, in particular in dependence upon a cancellation criterion such as a threshold value, by way of example a current threshold value or a time threshold value, and/or in dependence upon a travel distance estimation or travel distance calculation. Since the system is altogether self-locking, after achieving the end position of the actuator element 10, said actuator element remains in its respective position that has been achieved without supplying further energy.

The electric motor 8 is preferably not allowed to coast freely after the actuating procedure has been terminated but rather conversely is actively braked in a braking operation.

FIG. 2 illustrates a corresponding schematic illustration of a procedure of actuating the electric motor 8 in the braking operation. A four-quadrant chopper 12, in particular an H-bridge, is provided that comprises a high side HS in relation to the electrical potential and a low side LS relative to the high HS of the electrical potential. The low side LS may in particular be connected to ground. The electric motor 8 comprises two motor connectors 13, 13′ that in each case may be connected via a switching element on one side to the high side HS and on the other side to the low side LS. A first motor connector 13 is connected to the high side via a first switching element HS1 and to the low side LS via a second switching element LS1. A second motor connector 13′ is connected via a third switching element HS2 to the high side HS and using a fourth switching element LS2 to the low side LS. The switching elements are preferably configured as field effect transistors, in particular as MOSFETs. In the braking operation—as is illustrated in FIG. 2—the first switching element HS1 and the third switching element HS2 are closed, wherein the second switching element LS1 and the fourth switching element LS2 are open. Alternatively however, it is also possible that the second switching element LS1 and the fourth switching element LS2 are closed, wherein the first switching element HS1 and the third switching element HS2 are open. In any case, on one of the two sides HS, LS of the four-quadrant chopper 2—in FIG. 2 on the high side HS—a short circuit is produced for the electric motor 8, wherein the electric motor 8 that is coasting acts as a current source and generates the short circuit current i_{A}(t) that is indicated schematically in FIG. 2 by means of arrows. The electric motor 8 is actively braked by means of the voltage that is induced in this manner.

Whilst the motor is coasting, at least one motor coasting variable is ascertained, wherein with reference to the ascertained motor coasting variable a check is performed as to whether the actuator element 10 has been displaced into the predetermined position.

It is possible that a motor angular velocity of the electric motor 8, an induced motor voltage that may in particular be tapped at the motor connectors 13, 13′, and/or a motor current through the electric motor 8 is/are ascertained as a motor coasting variable. In the case of the exemplary embodiment that is illustrated in FIG. 2, a motor current is ascertained in a redundant manner by means of two current measuring devices 14, 14′, wherein a first current measuring device 14 is arranged electrically between the first switching element HS1 and the first motor connector 13. The second current measuring device 14′ is, electrically arranged between the third switching element HS2 and the second motor connector 13′. The current through the electric motor 8 may be measured in a redundant manner using the two current measuring devices 14, 14′ Alternatively, it is also possible that the two current measuring devices 14, 14′ are allocated together either electrically to the first motor connector 13 with the result that said current measuring devices by way of example in a modified FIG. 2 would both be arranged on the position of the current measuring device 14 that is illustrated in FIG. 2, or that said current measuring devices are both allocated to the second motor connector 13′, wherein said current measuring devices would both be arranged on the first position of the second current measuring device 14′ that is illustrated in FIG. 2. The current measuring devices 14, 14′ are preferably connected in series.

A control device that is not illustrated is preferably provided so as to actuate the actuator 7, in particular also to terminate the actuating procedure in dependence upon parameters and so as to ascertain and evaluate the motor coasting variable.

FIG. 3 illustrates a diagram of a braking procedure for the electric motor 8 without a load torque occurring. The motor current i_{A}(t) is plotted as a continuous curve against the time t, the motor angular velocity ω(t) is plotted as a dashed curve against the time t, and a brake application force F_{z}(t) that acts upon the output of the electric motor 8 is plotted as a dotted curve against the time t. The occurrence of the braking operation is illustrated using two circles K1.

In the case of the embodiment of the method that is illustrated schematically for operating the braking mechanism 1 a temporal development of a gradient, namely a temporal gradient, of the motor current i_{A}(t) is evaluated as a motor coasting variable. Gradients that occur at different times are illustrated as dot-dashed straight lines G on the curve of the motor current i_{A}(t). It is evident that if a load torque does not occur, a continuous development of the gradient is observed. This means that the actuator element 10 achieves a position in which a further final clearance is present. A final clearance of the actuator element 10 is therefore identified if a continuous development of the gradient G is observed.

FIG. 4 illustrates schematically a braking procedure with an occurring load torque. Identical and functionally identical elements are provided with identical reference numerals with the result that in this respect reference is made to the above description. In turn, the braking operation also starts at the point in time that is characterized by means of the circles K1. At a later point in time that is marked by means of the circles K2 an increased load torque occurs by way of example by means of the actuator element 10 being stopped on the brake piston 6 or by means of an initial brake application force, as a result of which at this point in time a jump in relation to the motor angular velocity ω(t) and the motor current i_{A}(t) occurs. This increase in force may also be detected by means of a procedure of identifying an increase in force.

The non-differentiable bend of the motor coasting variable leads to a discontinuity in the temporal development of the gradient E, as a result of which a load change is identified.

FIG. 5 illustrates schematically an embodiment of the method for operating a braking mechanism 1. In a first step S1 a displacement of the actuator element 10 is started by means of actuating the actuator 7 and in particular the electric motor 8, wherein the actuator element 10 is actuated in the direction of a brake application position—either so as to reduce a clearance or to build up an initial clamping force. In a second step S2, the idle running rotational speed of the electric motor 8 is achieved. In a third step S3, a travel distance calculation is performed for the actuator element 10 by way of example on the basis of a voltage measurement and/or the procedure for determining an actuation time. In a fourth step S4, a procedure of actuating the electric motor 8 is terminated in dependence upon at least one parameter and a braking operation for the electric motor 8 is started, wherein in the braking operation a motor coasting variable is ascertained and with reference to said motor coasting variable a check is performed as to whether the actuator element 10 has been displaced into the predetermined position. In a fifth step S5 the electric motor 8 comes to a standstill.

In a sixth step S6 the ascertained motor coasting variable is evaluated and a check is performed as to whether an initial clamping force or brake application force has been built up, in particular in that a check is performed as to whether a gradient of the motor coasting variable has shown a continuous development or a discontinuity in the development.

If a continuous development of the gradient is observed it is concluded that a final clearance is still present in the end position that is achieved by the actuator element 10. In a seventh step S7, a check is performed as to whether the predetermined position encompasses this final clearance or whether conversely an initial buildup of clamping force was desired. If an initial buildup of clamping force was desired, there is therefore a situation in which a discontinuity in the development of the gradient was expected but a continuous development was observed, in an eighth step S8 an additional procedure of actuating the electric motor 8 is performed that is actuated back into the original actuating procedure, therefore a procedure of actuating the electric motor 8 in the brake application direction. It is possible that after this actuating procedure it is assumed in advance that the predetermined position is achieved, wherein the method is terminated in a ninth step S9, however, it is also possible that the method is performed in a recursive manner, wherein after the repeated actuating procedure is terminated, a check is performed in turn as to whether the predetermined position has been achieved.

If a discontinuity in the development of the gradient is observed and consequently an initial buildup of brake application force is identified, in a tenth step S10 a check is performed as to whether this was desired or whether the predetermined position conversely should encompass a final clearance. If a final clearance was actually desired, in other words a continuous development of the gradient is expected but a discontinuity in the development is observed, in an eleventh step S11 a reversing procedure of actuating the electric motor 8 is performed, in other words an actuation in the direction of the release position is performed. It is also in turn possible that after the repeated actuating procedure in the eleventh step S11 it is assumed in advance that the predetermined position is achieved and the method is terminated in the ninth step S9. However, it is also possible that the method—as already described above—is implemented in a recursive manner.

However, if the respective expected gradient development is observed in the steps S7, S10, it is concluded that the actuator element 10 has achieved its predetermined position with the result that the method is directly terminated in the ninth step S9 without going through the steps S8, S11.

1. A method for operating a braking mechanism, comprising:
actuating an actuator including an electric motor to displace an actuator element into a predetermined position;
ascertaining at least one motor coasting variable after a procedure of actuating the actuator is terminated; and
performing a check with reference to the ascertained at least one motor coasting variable as to whether the actuator element has been displaced into the predetermined position.

2. The method as claimed in claim 1, further comprising:
terminating the procedure of actuating the actuator in dependence upon parameters.

3. The method as claimed in claim 1, wherein the at least one motor coasting variable is at least one of a motor angular velocity of the electric motor, a motor voltage of the electric motor, and a motor current through the electric motor.

4. The method as claimed in claim 1, further comprising:
evaluating a temporal development of a gradient of the at least one motor coasting variable; and
at least one of:
a) identifying a clearance of the actuator element if a continuous development of the gradient is observed,
b) identifying a load change of the actuator if a discontinuity in the development of the gradient is observed, and
c) performing an additional procedure of actuating the actuator in the case of at least one of (i) an expected continuous development of the gradient and an observed discontinuity in the development of the gradient, and (ii) an expected discontinuity in the development of the gradient and an observed continuous development of the gradient.

5. The method as claimed in claim 1, further comprising:
at least one of:
a) performing a reversing procedure of actuating the actuator in the case of an expected continuous development and an observed discontinuity in a development of a gradient of the motor coasting variable; and
b) performing a procedure of actuating the actuator back into the original actuating procedure in the case of an expected discontinuity in the development and an observed continuous development of the gradient.

6. The method as claimed in claim 1, further comprising:
operating the electric motor in a braking operation after the actuating procedure is terminated,
wherein in the braking operation preferably two switching elements of a same side of two sides of a four-quadrant chopper are closed and two switching elements of the other side of the two sides of the four-quadrant chopper are open.

7. The method of claim 1, wherein a control device for a braking mechanism, is configured to implement the method.

8. A braking mechanism for a vehicle, comprising:
an actuator that includes an electric motor; and
a control device configured to implement a method for operating the braking mechanism, the method including:
actuating an actuator including an electric motor to displace an actuator element into a predetermined position;
ascertaining at least one motor coasting variable after a procedure of actuating the actuator is terminated; and
performing a check with reference to the ascertained at least one motor coasting variable as to whether the actuator element has been displaced into the predetermined position.

9. The braking mechanism as claimed in claim 8, wherein at least one current measuring device is allocated to the electric motor and the current measuring device is arranged electrically between a switching element of a four-quadrant chopper and a motor connector of the four-quadrant chopper for the electric motor.

10. A vehicle comprising:
a braking mechanism including:
an actuator having an electric motor; and
a control device configured to implement a method for operating the braking mechanism, the method including:
actuating an actuator including an electric motor to displace an actuator element into a predetermined position;
ascertaining at least one motor coasting variable after a procedure of actuating the actuator is terminated; and
performing a check with reference to the ascertained at least one motor coasting variable as to whether the actuator element has been displaced into the predetermined position.
